(19) United States
(12) Patent Application Publication
(10) Pub. No.: US 2005/0123867 A1
(43) Pub. Date: Jun. 9, 2005

(54) Silver halide elements containing activated precursors to thiocyanato stabilizers

(75) Inventors: Roger Lok, Hilton, NY (US); Paul A. Zielinski, Rochester, NY (US); Mary C. Brick, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/727,833

(22) Filed: Dec. 4, 2003

(51) Int. Cl. G03C 1/46

(52) U.S. Cl. 430/502

(57) ABSTRACT

This invention relates to a silver halide photographic element comprising a support and a silver halide emulsion layer, said emulsion layer being in reactive association with a thiocyanato compound represented by formula I:
PUG-SCN (I) wherein PUG represents a photographically useful group; and wherein upon chemical processing, PUG-SCN releases in a non-image-wise fashion a photographically useful mercaptan, PUG-S.

### FIELD OF THE INVENTION

This invention relates to the use of certain thiocyanato compounds also known as cyanomercapto compounds as shoulder and speed enhancers in silver halide photographic elements.

### BACKGROUND OF THE INVENTION

With the advent of digital photography brought about by advances in image science and electronics, the traditional silver halide photographic materials are faced with alternative photographic technologies that are available to consumers. One way for the conventional silver halide photographic materials to stay competitive is to drive the cost of manufacturing to as low as possible and still maintain the high quality of silver halide based images. One means of achieving a low cost silver halide photographic material is to reduce the amount of the light sensitive silver halide used for producing such materials. The silver halide, comprising halide and silver, is a costly raw material, and accounts for a good percentage of the manufacturing cost of the light sensitive material. Thus a reduction in the use of silver halide will substantially reduce the cost of material. However, a reduction in silver halide coverage will bring about not only a loss in the maximum density of the D-log E curve, but a reduction in shoulder density as well. Such a shoulder density loss cannot be tolerated in a high quality photographic product. Among its drawbacks is a reduction in contrast, which is related to the shoulder part of the D-log E curve. A low contrast photographic material will lose image information that is otherwise present in a high contrast material. For example, low contrast results in poor discrimination between the highlights and the shadows of the developed image resulting in customer dissatisfaction. Therefore, it is desired that technologies be developed such that a high shoulder density is obtained. Materials that are used to increase the shoulder part of the D-log-E curve are sometimes called tone scale modifiers. U.S. Pat. No. 5,429,919 teaches the use of certain heterocycles to obtain silver photographic elements with increased contrast. U.S. Pat. No. 6,468,728 describes the use of certain carbonimidosulphones to obtain steep gradation of a silver halide material.

Sensitivity (or “speed”) of an emulsion is usually defined as the reciprocal of the exposure expressed in log scale needed to produce 0.8 density. Because it is desirable to improve the sensitivity of silver halide crystals, and hence the photographic elements in which they are contained, photographic chemists have over the years attempted to vary the processes for making, or the components within, silver halide emulsions. It has been recognized in the art that photographic sensitivity (speed) can be increased by adjusting the pH and/or the pAg of a silver halide emulsion. It has also been known that enhanced photographic sensitivity can be obtained by the addition of certain types of chemical sensitizers. Several types of sensitizers have been identified. The most prevalent are gold and sulfur compounds, both of which are thought to enhance emulsion speed by forming electron or photohole traps on the silver halide crystal surface. Sensitization has also been accomplished by the addition of other transition metals. Specifically, platinum salts have been used, although sensitization with such salts is strongly retarded by gelatin. In addition, iridium salts and complex ions of rhodium, osmium, and ruthenium have been used as chemical sensitizers. The overall effect of these metals on sensitivity appears to be dependant upon their valence state.

The ability of certain alkynylamines to produce increases in speed when incorporated into photographic emulsions as grain surface modifiers (post-precipitation) has been described in prior U.S. Pat. Nos. 4,378,426 and 4,451,557. Reduction sensitization is another means by which sensitivity enhancement can be obtained. Known reducing agents include stannous chloride, ascorbic acid (as in European Patent Applications 0369491 and 0369424) and dimethylamine borane (U.S. Pat. Nos. 4,150,093 and 3,782,959). However, the use of such sensitizers, as well as other types of sensitizers described above, often cause an increase in fog.

Problems with fogging have plagued the photographic industry from its inception. Fog is a deposit of silver or dye that is not directly related to the image-forming exposure, i.e., when a developer acts upon an emulsion layer, some reduced silver is formed in areas that have not been exposed to light. Fog can be defined as a developed density that is not associated with the action of the image-forming exposure, and is usually expressed as “D-min”, the density obtained in the unexposed portions of the emulsion. Density, as normally measured, includes both that produced by fog and that produced as a function of exposure to light. It is known in the art that the appearance of photographic fog related to intentional or unintentional reduction of silver ion (reduction sensitization) can occur during many stages of preparation of the photographic element including silver halide emulsion preparation, spectral/chemical sensitization of the silver halide emulsion, melting and holding of the liquid silver halide emulsion melts, subsequent coating of silver halide emulsions, and prolonged natural and artificial aging of coated silver halide emulsions.

The chemicals used for preventing fog growth as a result of aging or storage are generally known as emulsion stabilizers. Prolonged storage, heat and high humidity often exacerbate such fog growth. Emulsion or raw stock stabilization is often referred to as storage stability or raw stock keeping (RSK).

The control of fog, whether occurring during the formation of the light-sensitive silver halide emulsion, during the spectral/chemical sensitization of those emulsions, during the preparation of silver halide compositions prior to coating on an appropriate support, or during the aging of such coated silver halide compositions, has been attempted by a variety of means. Mercury-containing compounds, such as those described in U.S. Pat. Nos. 2,728,663; 2,728,664; and 2,728,665, have been used as additives to control fog. Thiosulfonates and thiosulfonate esters, such as those described in U.S. Pat. Nos. 2,440,206; 2,934,198; 3,047,393; and 4,960,689 have also been employed. Organic dichalcogenides, for example, the disulfide compounds described in U.S. Pat. Nos. 1,962,133; 2,465,149; 2,756,145; 2,935,404; 3,184,313; 3,318,701; 3,409,437; 3,447,925; 4,243,748; 4,463,082; and 4,788,132 have been used not only-to prevent formation of fog but also as desensitizers and as agents in processing baths and as additives in diffusion transfer systems. Organic compounds having a polysulfur linkage comprised of three or more sulfur atoms, and organic compounds having a heterocyclic ring having at least two thioether linkages or at least one disulfur linkage, such as those described in U.S. Pat. No. 5,116,723, in combination with nitrogen-containing cyclic compounds have also been discussed as suppressing fog and improving raw stock stability.

For highly sensitive silver chloride emulsions, storage fog is of particular concern. For these silver chloride emulsions, mercapto compounds and mercury salts are especially useful. The problem with stabilizers such as mercaptans and mercury salts is that when used in sufficient quantities to stabilize fog formation after storage, such stabilizers reduce the sensitivity of the emulsion considerably. Thus it is required that a mercaptan antifoggant be protected such that no sensitivity is lost when a sufficient amount is used to stabilize the emulsion. At the same time, it is also required that during incubation, when the temperature and humidity are high, the lability of the protecting group be sufficient to allow the mercaptan group to be revealed and the stabilizing function performed. Mercury compounds have the additional disadvantage of being harmful to the environment.

Mercaptan precursors have been taught in the photographic art. Azoles which hydrolyze in alkaline solution to yield mercaptoazoles are discussed in U.S. Pat. No. 3,260,597. U.S. Pat. No. 3,615,617 discusses the use of thiocarbonic acid esters and thiocarbamates as emulsion stabilizers. U.S. Pat. No. 4,840,871 describes a number of mercaptotetrazoles in which the mercaptan group is bonded to alkali labile substituents including sulfonylethyl groups (—CH₂CH₂SO₂R). U.S. Pat. No. 4,511,644 discusses the use of an alkoxycarbonylethyl (—CH₂CH₂COOR) moiety as a mercapto protecting group in a color diffusion transfer photographic element.

Alkoxycarbonyl (—COOR) protected mercapto heterocycles have also been mentioned in the photographic art. GB 1,186,441 discusses the stabilization of developed silver images with alkoxycarbonyl mercaptans in black and white photography. U.S. Pat. No. 3,364,028 describes the use alkoxycarbonyl mercaptans as yellow fog-preventing agents in photographic materials. U.S. Pat. Nos. 3,751,249 and 3,839,041 report the use alkoxycarbonyl mercaptan compounds for stabilization of the developed image in photothermographic elements. U.S. Pat. No. 4,952,491 discusses the use of alkoxycarbonyl protected mercaptan compounds in tabular silver chloride emulsions. U.S. Pat. No. 5,478,721 describes the use of similarly protected mercaptans in non-tabular silver chloride emulsions. One problem with the alkoxycarbonylmercaptans is that the protecting group does not have sufficient lability to fully allow the antifogging activity of the mercaptan compound to be realized during storage of the photographic coatings. U.S. Pat. No. 3,791,830 discusses the use of arylsulfonylethoxycarbonyl (—COOCH₂CH₂SO₂Ar) and arylthioethoxycarbonyl (—COOCH₂CH₂SAr) protected mercaptans in silver bromoiodide emulsions in color negative films. U.S. Pat. Nos. 6,280,922 and 5,478,721 discuss the use of arylsulfonylethoxycarbonyl (—COOCH₂CH₂SO₂Ar) protected mercaptans in silver chloride emulsions for use in color photographic papers.

In general, there has been a need in the industry for efficiently blocked compounds that are released in a non-imagewise fashion. More specifically, despite the vast amount of effort that has gone into methods of fog control in photographic elements, there is a continuing need in the industry for practical and environmentally benign stabilizers, particularly for high chloride emulsions, which do not otherwise adversely affect the performance of the photographic element. Further, there is a need to provide a low cost and efficient preparation of low cost emulsion additives such that the unit manufacturing cost of silver halide photographic materials are kept to a minimum.

### SUMMARY OF THE INVENTION

This invention relates to a photographic element comprising a support, and a silver halide emulsion layer, wherein said emulsion layer is in reactive association with a thiocyanato compound represented by formula I
PUG-SCN (I)
wherein PUG represents a photographically useful group; and wherein upon chemical development, PUG-SCN releases in a non-image-wise fashion a photographically useful mercaptan, PUG-S.

This invention provides a new class of compounds which release a photographically useful group in a non-imagewise fashion. In a specific embodiment the photographic elements of this invention have enhanced contrast with an increase in the shoulder part of the D log-E curve. Also observed is an increase in photographic speed, which relates to an improvement in photographic sensitivity. There is also improved resistance to storage-induced changes such as fog formation brought on by prolonged storage at high temperature and humidity. The thiocyanato compounds contained in the silver halide elements of this invention may unzip during storage of the photographic element releasing the antifogging mercaptan. The released mercaptan may further fragment yielding other PUGs. Alternatively, the thiocyanato compound may generate the antifogging mercapto compound during development thus inhibiting the formation of development fog without deleteriously impacting the emulsion layer's fresh (i.e., unstored) sensitivity.

### DETAILED DESCRIPTION OF THE INVENTION

The compounds utilized in the photographic elements of this invention are thiocyanato compounds represented by formula I
PUG-SCN (I)
such that upon chemical development PUG-SCN cleaves between the sulfur atom and the carbon atom of SCN and releases the mercaptan PUG-S. PUG-SCN is not a coupler compound. It does not react with oxidized developer to form PUG and SCN. Rather it releases PUG-S in a non-imagewise fashion. The term non-imagewise is used to mean a process (the release chemistry) occurring not as a result of interaction of the exposed sensitivity sites with the developer resulting in generation of the oxidized developer, which when coupled with the coupler, produces the image dye. The release chemistry may happen as a result of nucleophilic attack on the thiocyanato carbon atom by species such as hydroxide, hydroxylamine in the developer or water at the elevated temperature (ranging from 80 to 105° F.) that is prevalent under processing conditions. In one embodiment the most important species is hydroxide ion, which results from a high pH, preferably greater than 8, and more preferably greater than 9. The released fragment, PUG-S⁻ may, depending on the structure of the fragment, further give way to other species that may be photographically useful.

PUG represents a photographically useful group. The PUG can be any PUG known in the art providing it can be substituted with SCN and does not inhibit the cleavage of the SCN group to release the mercaptan compound. Examples of PUGs include development inhibitors, bleach accelerators, development accelerators, dyes, bleach inhibitors, developers, silver complexing agents, fixing agents, image toners, stabilizers, hardeners, tanning agents, fogging agents, tone scale modifiers, ultraviolet radiation absorbers, antifoggants, nucleators, chemical or spectral sensitizers and desensitizers. The PUG must be one that is useful when it is released in a non-image-wise fashion. Preferably PUG is an antifoggant or a tone scale modifier.

Such PUGs may preferably be represented by a substituted or unsubstituted aliphatic, aromatic or heteroaromatic group. The aliphatic groups preferably have from 2 to 12 carbon atoms, and may have heteroatoms in the chain. Examples of aliphatic groups include, but are not limited to, straight- or branched-chain alkyl groups, such as methyl, trifluoromethyl, ethyl, t-butyl, 3-(2,4-di-t-pentylphenoxy) propyl, and tetradecyl; alkenyl groups, such as ethylene, 2-butene, carboxyalkyl groups such as carboxyethyl, or sulfoalkyl groups such as sulfopropyl. An aromatic or heteroaromatic group may be a ring or a ring system. The preferred aromatic groups have from 6 to 20 carbon atoms. More preferably, the aromatic groups have 6 to 10 carbon atoms and include, among others, phenyl and naphthyl groups. The heteroaromatic groups are 3- to 15-membered rings, more preferably 5- to 6-membered rings, with at least one atom selected from nitrogen, oxygen, sulfur, selenium and tellurium. More preferably, the heteroaromatic groups are 5- to 6-membered rings with at least one atom selected from nitrogen. Examples of suitable heteroaromatic groups include, but are not limited to, pyridine, thiophene, oxazole, thiazole, imidazole, benzothiazole, benzoxazole, benzimidazole, selenazole, benzoselenazole, tellurazole, triazole, benzotriazole, tetrazole, oxadiazole, or thiadiazole rings. Preferably PUG represents a heteroaromatic group. More preferably PUG represents a substituted heteroaromatic group. Most preferably PUG represents a substituted or unsubstituted phenyl substituted tetrazole.

Unless otherwise specifically stated, substituent groups which may be substituted on molecules herein include any groups, whether substituted or unsubstituted, which do not destroy properties necessary for photographic utility. When the term “group” is applied to the identification of a substituent containing a substitutable hydrogen, it is intended to encompass not only the substituent's unsubstituted form, but also its form further substituted with any group or groups as herein mentioned. Suitably, the group may be halogen or may be bonded to the remainder of the molecule by an atom of carbon, silicon, oxygen, nitrogen, phosphorous, or sulfur. The substituent may be, for example, halogen, such as chlorine, bromine or fluorine; nitro; hydroxyl; cyano; carboxyl; or groups which may be further substituted, such as alkyl, including straight or branched chain alkyl, such as methyl, trifluoromethyl, ethyl, t-butyl, 3-(2,4-di-t-pentylphenoxy) propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-toluylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-toluylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-toluylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl; N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-toluylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-toluylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1 (N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3- to 7-membered heterocyclic ring composed of carbon atoms and at least one hetero atom selected from the group consisting of oxygen, nitrogen and sulfur, such as 2-furyl, 2-thienyl, 2-benzimidazolyloxy or 2-benzothiazolyl; quaternary ammonium, such as triethylammonium; and silyloxy, such as trimethylsilyloxy.

If desired, the substituents may themselves be further substituted one or more times with the described substituent groups. The particular substituents used may be selected by those skilled in the art to attain the desired photographic properties for a specific application and can include, for example, hydrophobic groups, solubilizing groups, blocking groups, releasing or releasable groups, etc.

Specific examples of the thiocyanato compounds include, but are not limited to:

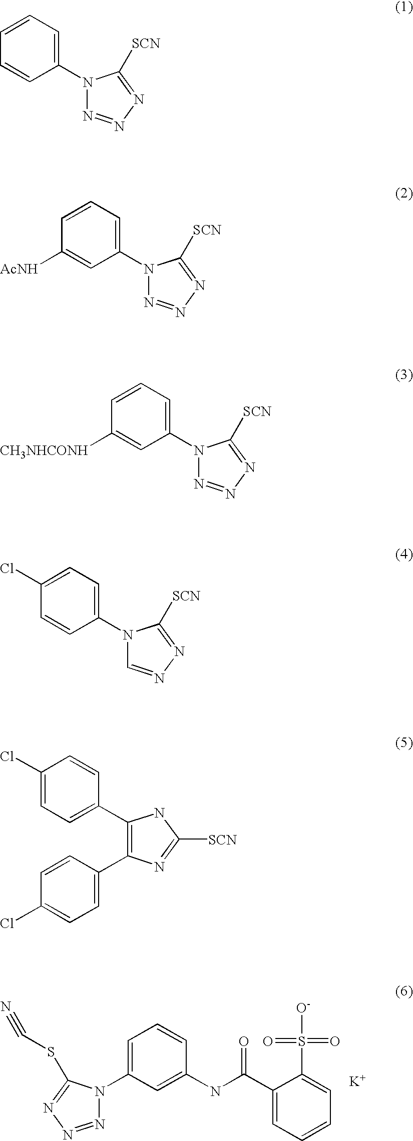

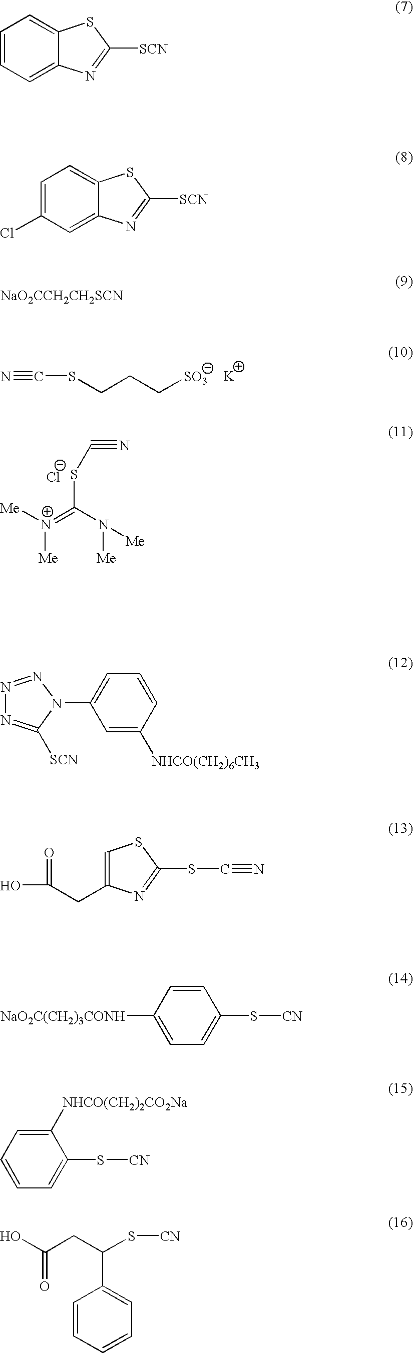

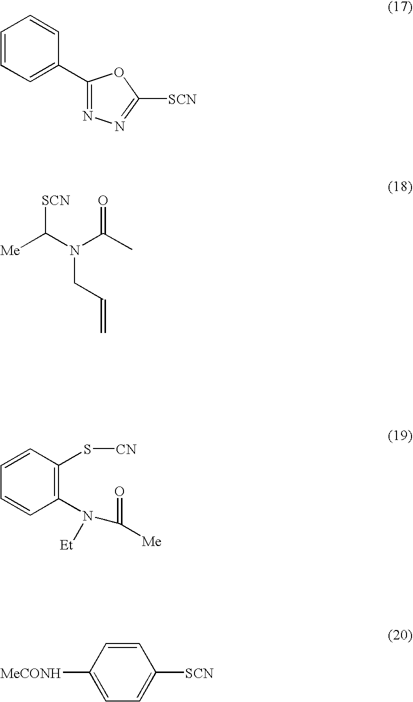

Thiocyanato compounds are known in the chemical literature. Synthesis of these compounds have been reported by K. Kottke, F. Friedrich, and R. Pohlodek-Fabini in Parhmazie (1973), 28(12-12), 736-7 and by R. Pohloudek-Fabini, K. Kottke, and F. Friedrich in Parhmazie (1969), 24(8), 433-8. For example, 1-aryl-5-mercaptotetrazoles react readily with cyanogen bromide to give the thiocyanate in nearly quantitative yield. Alternatively, thiocyanates may be prepared by treatment of the mercapto compound with a process wherein bromine and sodium cyanide are mixed together in situ. In general, these thiocyanato compounds can be made in one step from relatively cheap starting materials.

Useful levels of the thiocyanato compound may range from about 0.1 mg to about 5,000 mg per silver mole. The preferred range may be from about 1 mg to about 2,500 mg per silver mole. A more preferred range is from about 10 mg to about 1,000 mg per silver mole. The most preferred range is from about 100 mg to about 500 mg per Ag mole.

The compound can be incorporated into the imaging element by direct addition of the compound to a coating melt as an acetone or methanol solution, or in other suitable organic solvents. The compound can also be added by pre-mixing with an aqueous medium containing gelatin or other hydrophilic colloid. The compound can also be mixed with an aqueous solution of a water-soluble or water-dispersible surfactant or polymer, and passing the premix through a mill until the desired particle size is obtained. Various techniques for forming a liquid dispersion of the compound, including oil-in-water emulsions, are well known by the skilled artisan. An oil-in-water dispersion of the compound may be prepared by dissolving the compound in an organic liquid, forming a premix with an aqueous phase containing dispersing aids such as water-soluble surfactants, polymers and film forming binders such as gelatin, and passing the premix through a mill until the desired particle size is obtained. The mill can be any high-energy device such as a colloid mill, high-pressure homogenizer, or the like.

In the preferred embodiment, the compound is dispersed in a binder in the form of a solid particle dispersion as follows. Such dispersions are formed by first mixing the compound with an aqueous solution containing a water-soluble or water-dispersible surfactant or polymer to form a coarse aqueous premix, and adding the premix to a mill. The amount of water-soluble or water-dispersible surfactant or polymer can vary over a wide range, but is generally in the range of 0.01% to 100%, preferably about 0.3% to about 60%, and more preferably 0.5% to 50%, the percentages being by weight, based on the weight of the compound useful in this application.

The mill can be, for example, a ball mill, media mill, attritor mill, vibratory mill or the like. The mill is charged with the appropriate milling media such as, for example, beads of silica, silicon nitride, sand, zirconium oxide, yttria-stabilized zirconium oxide, alumina, titanium, glass, polystyrene, etc. The bead sizes typically range from 0.25 to 3.0 mm in diameter, but smaller media can be used if desired. The premix is milled until the desired particle size range is reached.

The solid compound particles are subjected to repeated collisions with the milling media, resulting in crystal fracture, deagglomeration, and consequent particle size reduction. The solid particle dispersions of the compound should have a final average particle size of less than the thickness of the dried layer in which they are coated, preferably less than 50 percent of the thickness of the dried layer. The particles should, therefore, have a median diameter of less than 2 microns, preferably between 0.01 and 2 micron, and most preferably between 0.01 and 1 micron. Most preferably, the median diameter of the solid compound particles are of sub-micron average size. Solid particle median diameters of between 0.01 and 0.5 micron provides the best compound utilization compared to dispersions with a median particle size greater than 1 micron, but particles greater than 1 micron may be present.

Surfactants, polymers, and other additional conventional addenda may also be used in the dispersing process described herein in accordance with prior art solid particle dispersing procedures. Such surfactants, polymers and other addenda are disclosed in U.S. Pat. Nos. 5,468,598, 5,300,394, 5,278,037, 4,006,025, 4,924,916, 4,294,917, 4,940,654, 4,950,586, 4,927,744, 5,279,931, 5,158,863, 5,135,844, 5,091,296, 5,089,380, 5,103,640, 4,990,431, 4,970,139, 5,256,527, 5,089,380, 5,103,640, 4,990,431, 4,970,139, 5,256,527, 5,015,564, 5,008,179, 4,957,857, and 2,870,012, British Patent specifications Nos. 1,570,362 and 1,131,179 referenced above, the disclosures of which are hereby incorporated by reference, in the dispersing process of the compound.

The thiocyanato compound may be added to any layer where they are in reactive association with the silver halide. By “in reactive association with” it is meant that the compounds must be contained in the silver halide emulsion layer or in a layer whereby they can react or interact with the silver halide emulsion. For example, the compounds can also be added to gelatin-only overcoats or interlayers. Combinations of more than one thiocyanato compound may be utilized. The thiocyanato compound may be used in addition to any conventional emulsion stabilizer or antifoggant as commonly practiced in the art. For example, the thiocyanato compound may be used in combination with an aromatic thiosulfonate represented by Formula A (ArSO₂SM) and aromatic sulfinate represented by Formula B (ArSO₂M). Ar is an aromatic group and M is a cationic counter ion.. The preferred aromatic groups have from 6 to 20 carbon atoms. More preferably, the aromatic groups have 6 to 10 carbon atoms and include, among others, phenyl and naphthyl groups. M is preferably an alkali metal or an ammonium group, with sodium and potassium ions being most preferred. Specific examples of Formulae A and B are shown below.

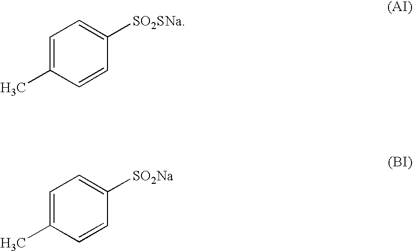

The photographic emulsions of this invention are generally prepared by precipitating silver halide crystals in a colloidal matrix by methods conventional in the art. The colloid is typically a hydrophilic film forming agent such as gelatin, alginic acid, or derivatives thereof.

The crystals formed in the precipitation step are washed and then chemically and spectrally sensitized by adding spectral sensitizing dyes and chemical sensitizers, and by providing a heating step during which the emulsion temperature is raised, typically from 40° C. to 70° C., and maintained for a period of time. The precipitation and spectral and chemical sensitization methods utilized in preparing the emulsions employed in the invention can be those methods known in the art.

Chemical sensitization of the emulsion typically employs sensitizers such as: sulfur-containing compounds, e.g., allyl isothiocyanate, sodium thiosulfate and allyl thiourea; reducing agents, e.g., polyamines and stannous salts; noble metal compounds, e.g., gold, platinum; and polymeric agents, e.g., polyalkylene oxides. As described, heat treatment is employed to complete chemical sensitization. Spectral sensitization is effected with a combination of dyes, which are designed for the wavelength range of interest within the visible or infrared spectrum. It is known to add such dyes both before and after heat treatment. After spectral sensitization, the emulsion is coated on a support. Various coating techniques include dip coating, air knife coating, curtain coating and extrusion coating.

The thiocyanato compound of this invention may be added to the silver halide emulsion at any time during the preparation of the emulsion, i.e., during precipitation, during or before chemical sensitization or during final melting and co-mixing of the emulsion and additives for coating. It may also be added to the coupler dispersion. Most preferably, these compounds are added during final melting and co-mixing of the emulsion with the dispersion.

The silver halide emulsions utilized in the invention may be comprised of any halide distribution. Thus, they may be comprised of silver bromoiodide, silver chloride, silver bromide, silver bromochloride, silver chlorobromide, silver iodochloride, silver iodobromide, silver bromoiodochloride, silver chloroiodobromide, silver iodobromochloride, and silver iodochlorobromide emulsions. In one embodiment silver bromoiodides with various morphologies and halide compositions may be utilized. Preferably, the silver halide emulsions utilized in this invention are predominantly silver chloride emulsions. By predominantly silver chloride, it is meant that the grains of the emulsion are greater than about 50 mole percent silver chloride. Preferably, they are greater than about 90 mole percent silver chloride; and optimally greater than about 95 mole percent silver chloride. Additionally, these emulsions may contain iodides or bromides or both of less than 50% of the total halide composition.

It is contemplated that the silver halide emulsions may contain grains of a variety of sizes and morphologies. Thus, the grain may take the form of cubes, octahedrons, cubooctahedrons or any of the other naturally occurring morphologies of cubic lattice type silver halide grains. Further, the grains may be irregular such as spherical or tabular grains. Tetradecahedral grains with {111} and {100} crystal faces may also be utilized. Grains having a cubic or tabular morphology are preferred.

The grains can be contained in any conventional dispersing medium capable of being used in photographic emulsions. Specifically, it is contemplated that the dispersing medium be an aqueous gelatino-peptizer dispersing medium, of which gelatin—e.g., alkali treated gelatin (cattle bone and hide gelatin) or acid treated gelatin (pigskin gelatin) and gelatin derivatives—e.g., acetylated gelatin, phthalated gelatin and the like are specifically contemplated. When used, gelatin is preferably at levels of 0.01 to 100 grams per total silver mole The photographic emulsions may be incorporated into black and white or color negative (particularly color paper) or reversal photographic elements. The photographic elements of the invention can be single color elements or multicolor elements. The supports utilized in this invention are preferably reflective supports such as are known in the art. Multicolor elements contain image dye-forming units sensitive to each of the three primary regions of the spectrum. Each unit can comprise a single emulsion layer or multiple emulsion layers sensitive to a given region of the spectrum. The layers of the element, including the layers of the image-forming units, can be arranged in various orders as known in the art. In an alternative format, the emulsions sensitive to each of the three primary regions of the spectrum can be disposed as a single segmented layer.

A typical multicolor photographic element comprises a support bearing a cyan dye image-forming unit comprised of at least one red-sensitive silver halide emulsion layer having associated therewith at least one cyan dye-forming coupler, a magenta dye image-forming unit comprising at least one green-sensitive silver halide emulsion layer having associated therewith at least one magenta dye-forming coupler, and a yellow dye image-forming unit comprising at least one blue-sensitive silver halide emulsion layer having associated therewith at least one yellow dye-forming coupler. The element can contain additional layers, such as filter layers, interlayers, overcoat layers, subbing layers, and the like.

If desired, the photographic element can be used in conjunction with an applied magnetic layer as described in Research Disclosure, November 1992, Item 34390 published by Kenneth Mason Publications, Ltd., Dudley Annex, 12a North Street, Emsworth, Hampshire PO10 7DQ, ENGLAND, and as described in Hatsumi Kyoukai Koukai Gihou No. 94-6023, published Mar. 15, 1994, available from the Japanese Patent Office, the contents of which are incorporated herein by reference. When it is desired to employ the inventive materials in a small format film, Research Disclosure, June 1994, Item 36230, provides suitable embodiments.

In the following Table, reference will be made to (1) Research Disclosure, December 1978, Item 17643, (2) Research Disclosure, December 1989, Item 308119, (3) Research Disclosure, September 1994, Item 36544, and (4) Research Disclosure, September 1996, Item 38957, all published by Kenneth Mason Publications, Ltd., Dudley Annex, 12a North Street, Emsworth, Hampshire PO10 7DQ, ENGLAND, the disclosures of which are incorporated herein by reference. The Table and the references cited in the Table are to be read as describing particular components suitable for use in the elements of the invention. The Table and its cited references also describe suitable ways of preparing, exposing, processing and manipulating the elements, and the images contained therein. High chloride photographic elements and methods of processing such elements particularly suitable for use with this invention are described in Research Disclosure, February 1995, Item 37038, in Research Disclosure, September 1997, Item 40145 and, of particular interest, Research Disclosure, September 2000, Item 437013 published by Kenneth Mason Publications, Ltd., Dudley Annex, 12a North Street, Emsworth, Hampshire PO10 7DQ, ENGLAND, the disclosures of which are incorporated herein by reference.

| Reference | Section | Subject Matter |
|---|---|---|
| 1 | I, II | Grain composition, |
| 2 | I, II, IX, X, XI, XII, | morphology and preparation. |
| | XIV, XV | Emulsion preparation |
| 3 & 4 | I, II, III, IX A & B | including hardeners, coating |
| | | aids, addenda, etc. |
| 1 | III, IV | Chemical sensitization and |
| 2 | III, IV | spectral sensitization/ |
| 3 & 4 | IV, V | desensitization |
| 1 | V | UV dyes, optical brighteners, |
| 2 | V | luminescent dyes |
| 3 & 4 | VI | |
| 1 | VI | Antifoggants and stabilizers |
| 2 | VI | |
| 3 & 4 | VII | |
| 1 | VIII | Absorbing and scattering |
| 2 | VIII, XIII, XVI | materials; Antistatic layers; |
| 3 & 4 | VIII, IX C & D | matting agents |
| 1 | VII | Image-couplers and image- |
| 2 | VII | modifying couplers; Wash-out |
| 3 & 4 | X | couplers; Dye stabilizers and |
| | | hue modifiers |
| 1 | XVII | Supports |
| 2 | XVII | |
| 3 & 4 | XV | |
| 3 & 4 | XI | Specific layer arrangements |
| 3 & 4 | XII, XIII | Negative working emulsions; |
| | | Direct positive emulsions |
| 2 | XVIII | Exposure |
| 3 & 4 | XVI | |
| 1 | XIX, XX | Chemical processing; |
| 2 | XIX, XX, XXII | Developing agents |
| 3 & 4 | XVIII, XIX, XX | |
| 3 & 4 | XIV | Scanning and digital |
| | | processing procedures |

The photographic elements may utilize any traditional support known to those skilled in the art. One conventional photographic quality paper comprises cellulose paper with polyethylene resin waterproof coatings. The support may also consist of a multilayer film of biaxially oriented polyolefin which is attached to both the top and bottom of a photographic quality paper support by melt extrusion of a polymer tie layer. The biaxially oriented films may contain a plurality of layers in which at least one of the layers contains voids. The voids provide added opacity to the imaging element. This voided layer can also be used in conjunction with a layer that contains at least one pigment from the group consisting of TiO₂, CaCO₃, clay, BaSO₄, ZnS, MgCO₃, talc, kaolin, or other materials that provide a highly reflective white layer in said film of more than one layer. The combination of a pigmented layer with a voided layer provides advantages in the optical performance of the final image. These supports are described in more detail in U.S. Pat. Nos. 5,866,282; 5,888,681; 6,030,742; 6,030,759; 6,107,014; and 6,153,351. Such biaxially oriented films may also be utilized for display materials having translucent or transparent supports.

Photographic elements can be exposed to actinic radiation, typically in the visible region of the spectrum, to form a latent image and can then be processed to form a visible dye image. Chemical processing to form a visible dye image includes the step of contacting the element with a color developing agent to reduce developable silver halide and oxidize the color developing agent. Oxidized color developing agent in turn reacts with the coupler to yield a dye.

With negative-working silver halide, the processing step described above provides a negative image. One type of such element, referred to as a color negative film, is designed for image capture. Speed (the sensitivity of the element to low light conditions) is usually critical to obtaining sufficient image in such elements. Such elements are typically silver bromoiodide emulsions coated on a transparent support and are sold packaged with instructions to process in known color negative processes such as the Kodak C-41 process as described in The British Journal of Photography Annual of 1988, pages 191-198. If a color negative film element is to be subsequently employed to generate a viewable projection print as for a motion picture, a process such as the Kodak ECN-2 process described in the H-24 Manual available from Eastman Kodak Co. may be employed to provide the color negative image on a transparent support. Color negative development times are typically 3′ 15″ or less and desirably 90 or even 60 seconds or less.

The photographic element of the invention can be incorporated into exposure structures intended for repeated use or exposure structures intended for limited use, variously referred to by names such as “single use cameras”, “lens with film”, or “photosensitive material package units”.

Another type of color negative element is a color print. Such an element is designed to receive an image optically printed from an image capture color negative element. A color print element may be provided on a reflective support for reflective viewing (e.g., a snapshot) or on a transparent support for projection viewing as in a motion picture. Elements destined for color reflection prints are provided on a reflective support, typically paper, employ silver chloride emulsions, and may be optically printed using the so-called negative-positive process where the element is exposed to light through a color negative film which has been processed as described above. The element is sold packaged with instructions to process using a color negative optical printing process, for example the Kodak RA-4 process, as generally described in PCT WO 87/04534 or U.S. Pat. No. 4,975,357, to form a positive image. Color projection prints may be processed, for example, in accordance with the Kodak ECP-2 process as described in the H-24 Manual. Color print development times are typically 90 seconds or less and desirably 45 or even 30 seconds or less.

Preferred color developing agents are p-phenylenediamines such as:
4-amino-N,N-diethylaniline hydrochloride,
4-amino-3-methyl-N,N-diethylaniline hydrochloride,
4-aamino-3-methyl-N-ethyl-N-(2-methanesulfonamidoethyl)aniline sesquisulfate hydrate,
4-amino-3-methyl-N-ethyl-N-(2-hydroxyethyl)aniline sulfate,
4-amino-3-(2-methanesulfonamidoethyl)-N,N-diethylaniline hydrochloride and
4-amino-N-ethyl-N-(2-methoxyethyl)-m-toluidine di-p-toluene sulfonic acid.

Development is usually followed by the conventional steps of bleaching, fixing, or bleach-fixing to remove silver or silver halide, washing, and drying.

The following examples illustrate the practice of this invention. They are not intended to be exhaustive of all possible variations of the invention. Parts and percentages are by weight unless otherwise indicated.

### EXAMPLES

Compound Preparations

Compound (1). A 150 mL solution of cyanogen bromide (24.9 g, 0.24 mol) in acetonitrile was added over 30 minutes to the sodium salt of 1-phenyl-5-mercaptotetrazole (47.0 g, 0.24 mol) dissolved in acetonitrile (350 ml). An exotherm to 35° C. was noted. Additional acetonitrile (100 mL) was added. The salt was filtered and the filtrate concentrated in vacuo at 60° C. to give a light amber oil that solidified to a white solid. M.P. 75-77° C. Yield: 44.4 g (93%). Purity by HPLC: 98.6%. NMR is consistent with structure.

Compound (1) from in situ generation of cvanogen bromide. To a chilled (10° C.) solution of bromine (8.0 g, 0.05 mol) in acetonitrile and water was added an aqueous solution of sodium cyanide (2.45 g) over 15 minutes. The mixture was cooled again to 10° C. when an aqueous solution of sodium salt of 1-phenyl-5-mercaptotetrazole (8.9 g, 0.05 mol) was slowly added. The mixture was stirred for another two hrs at 20° C. and then extracted several times with ether. The extracts were combined and dried. Concentration of the ether solution in vacuo at 40° C. gave a white solid weighing 9.3 g or 93% yield. Purity by HPLC: 95.6%. Both materials exhibit the 2200 cm⁻¹ peak characteristic of the thiocyanate stretching in the infrared spectrum.

Compound (2). Cyanogen bromide (4.23 g, 0.04 mol) was added to a solution of 1-(3-acetamido)phenyl-5-mercaptotetrazole (10.3 g, 0.04 mol) in methanol (175 ml). The mixture was refluxed for 20 minutes when a thick precipitate formed. The product was collected and washed with methanol and then with diethyl ether. The solutions were combined, dried and then concentrated in vacuo. Yield: 7.0 g (67%). Purity by HPLC: 98.6%. Both NMR and mass spectrum support the structure of compound (2). Infrared spectrum shows the characteristic peak of thiocyanate stretch at 2200 cm⁻¹.

Compound (3). 1-(3-N-Methylureido)phenyl-5-mercaptotetrazole. (10.0 g, 0.04 mol), sodium carbonate (3.36 g, 0.04 mol) was combined with methanol (175 ml) and the mixture heated at reflux for 20 m. Cyanogen bromide (4.23 g, 0.04 mol) was added and the mixture heated at reflux for an additional 30 m. A thick precipitate formed. The product was collected and washed with methanol and then with diethyl ether. Yield: 10.0 g of crude product. HPLC together with ¹H and APT NMR, IR and MS indicated that desired compound was present in ca. 90% concentration. Purity by HPLC: 89.4%.

Compound (6). A mixture of cyanogen bromide (4.6 g, 0.043 mol), 1-(3-(2-sulfobenzamido)phenyl-5-mercaptotetrazole (18.14 g, 0.04 mol) and methanol (175 mL) were combined and the mixture heated at reflux for 20 m. The mixture was chilled to 10° C. to give a thick precipitate. The mixture was filtered, and the solid washed repeatedly with acetone. The washes were combined and concentrated. The residue was vacuum dried at 25° C. Yield: 16.15 g (92%). Purity by HPLC: 98.8%.

Dispersion Preparations

Dispersion of compound (1). The following ingredients were combined in a 16-oz glass jar: 5.0 g of compound (1), 1.4 g of a 3.7% solution of dodecyl sodium sulfate in water, 4.0 g of a 10% solution of polyvinylpyrrolidone in water, 89.6 g of high purity water and 250 mL of 1.8 mm zirconium oxide ceramic beads. The jar was sealed and rolled at a speed of 78 ft/min for 5 days. After this time, the zirconium oxide beads were removed by filtration without dilution. Microscopic examination of the final dispersion showed well-dispersed, sub-micron particles.

Dispersion of compound (2). A dispersion of compound (2) was prepared in the same manner as the dispersion of (1) except that 5.0 g of compound (2) was used instead of compound (1). Microscopic examination of the final dispersion showed well-dispersed, sub-micron particles.

Dispersion of Compound (3). A dispersion of compound (3) was prepared in the same manner as the dispersion of (1) except that 5.0 g of compound (3) was used instead of compound (1). Microscopic examination of the final dispersion showed well-dispersed, sub-micron particles.

### Example 1

In accordance with the present invention, compounds (1) (in solid particle dispersion form, SPD, and in methanol) and (6) in amounts indicated in Table 1 were added to a 0.043 mol cubic silver iodochloride negative emulsion previously sensitized with a colloidal suspension of aurous sulfide, p-glutaramidophenyl disulfide, a blue spectral sensitizing dye, anhydro-5-chloro-3,3′-di(3-sulfopropyl)-5′-(1-pyrrolyl)-thiazolothiacyanine hydroxide triethylammonium salt, Lippmann bromide, potassium hexachloroiridate and 1-(3-acetamidophenyl)-5-mercaptotetrazole. This emulsion further contained a yellow dye-forming coupler, 4-chloro-3-((2-(5,5-dimethyl-2,4-dioxo-3-oxazolidinyl)-4,4-dimethyl-1,3-dioxopentyl)amino)-hexadecyl benzoic acid ester (0.416 g/m²) in t-butyl citrate coupler solvent (0.219 g/m²), gelatin (1.252 g/m²). The emulsion (0.239 g/m²) was coated on a resin coated paper support and 1.076 g/m² gel overcoat was applied as a protective layer along with the hardener bis (vinylsulfonyl) methyl ether in an amount of 1.8% of the total gelatin weight.

The coatings were given a 0.1 second exposure, using a 0-3 step tablet (0.15 increments) with a tungsten lamp designed to stimulate a color negative print exposure source. This lamp had a color temperature of 3000 K, log lux 2.95, and the coatings were exposed through a combination of magenta and yellow filters, a 0.3 ND (Neutral Density), and a UV filter. The processing consisted of a color development (45 sec, 35° C.), bleach-fix (45 sec, 35° C.) and stabilization or water wash (90 sec, 35° C.) followed by drying (60 sec, 60° C.). The chemistry used in the Colenta processor consisted of the following solutions:

Developer:

| | | |
|---|---|---|
| Lithium salt of sulfonated polystyrene | 0.25 | mL |
| Triethanolamine | 11.0 | mL |
| N,N-diethylhydroxylamine (85% by wt.) | 6.0 | mL |
| Potassium sulfite (45% by wt.) | 0.5 | mL |
| Color developing agent (4-(N-ethyl-N-2-methanesulfonyl | 5.0 | g |
| aminoethyl)-2-methyl-phenylenediaminesesquisulfate | | |
| monohydrate | | |
| Stilbene compound stain reducing agent | 2.3 | g |
| Lithium sulfate | 2.7 | g |
| Potassium chloride | 2.3 | g |
| Potassium bromide | 0.025 | g |
| Sequestering agent | 0.8 | mL |
| Potassium carbonate | 25.0 | g |
| Water to total of 1 liter, pH adjusted to 10.12 | | |

Bleach-fix

| | | |
|---|---|---|
| Ammonium sulfite | 58 | g |
| Sodium thiosulfate | 8.7 | g |
| Ethylenediaminetetracetic acid ferric ammonium salt | 40 | g |
| Acetic acid | 9.0 | mL |
| Water to total 1 liter, pH adjusted to 6.2 | | |

Stabilizer

| | | |
|---|---|---|
| Sodium citrate | 1 | g |
| Water to total 1 liter, pH adjusted to 7.2. | | |

The speed taken at the 0.8 density point of the D log E curve is taken as a measure of the sensitivity of the emulsion. D-min is measured as the minimum density above zero. Shoulder is measured at the point of the D log E curve 0.5 log E slow of the speed point.

TABLE 1

| | | mg | | | | |
|---|---|---|---|---|---|---|
| | | Ag | | | | |
| Sample | CPD | mol | Solvent | SPEED | D-MIN | SHOULDER |
| 1 (comparison) | None | 0 | none | 1.863 | 0.107 | 2.017 |
| 2 (invention) | (1) | 100 | MeOH | 1.870 | 0.105 | 2.055 |
| 3 (invention) | (1) | 251 | MeOH | 1.874 | 0.103 | 2.081 |
| 4 (invention) | (1) | 100 | SPD | 1.869 | 0.103 | 2.047 |
| 5 (invention) | (1) | 251 | SPD | 1.875 | 0.104 | 2.064 |
| 6 (invention) | (6) | 217 | water | 1.864 | 0.104 | 2.024 |
| 7 (invention) | (6) | 545 | water | 1.856 | 0.106 | 2.052 |

It can be seen in Table 1 that samples of the present invention (2-7) containing the inventive compounds (1) and (6) have enhanced shoulder compared to the control (sample 1) that has no thiocyanato compound added. It is also clear that samples (2-5) containing compound (1) show speed increase over that of the control sample and of samples 6 and 7, which contain compound (6), the less preferred material.

### Example 2

In another practice of the invention, compounds (1), (2) and (3) in amounts indicated in Table (2) were added to the same emulsion as in Example 1. The sensitized emulsions were then doctored, coated, exposed and processed as for Example 1. In addition the coatings were subjected to an accelerated keeping condition at 120° F. and 50% RH for four weeks.

The data in Table 2 show the changes in fog density (ΔDmin) and speed (ΔSpeed) of the blue sensitized coatings relative to those kept at 0° F.

TABLE 2

| | | | | | | 2 week | |
|---|---|---|---|---|---|---|---|
| | | mg | Fresh | | | 120 vs 0° F. | |
| Sample | CPD | Ag mol | Speed | D-min | Shoulder | ΔSpeed | ΔDmin |
| 8 (comparison) | None | 0 | 1.866 | 0.100 | 1.966 | 0.151 | 0.041 |
| 9 (invention) | (1) | 100 | 1.869 | 0.098 | 1.985 | 0.144 | 0.028 |
| 10 (invention) | (1) | 251 | 1.875 | 0.098 | 2.007 | 0.140 | 0.025 |
| 11 (invention) | (1) | 376 | 1.874 | 0.097 | 2.014 | 0.140 | 0.024 |
| 12 (invention) | (2) | 128 | 1.863 | 0.100 | 1.997 | 0.150 | 0.033 |
| 13 (invention) | (2) | 322 | 1.856 | 0.099 | 1.992 | 0.146 | 0.025 |
| 14 (invention) | (2) | 482 | 1.854 | 0.097 | 1.997 | 0.138 | 0.024 |
| 15 (invention) | (3) | 136 | 1.862 | 0.100 | 1.982 | 0.151 | 0.030 |
| 16 (invention) | (3) | 340 | 1.854 | 0.098 | 2.007 | 0.137 | 0.026 |
| 17 (invention) | (3) | 510 | 1.847 | 0.098 | 1.997 | 0.126 | 0.022 |

The data in Table 2 show that samples (9-17) containing compounds (1), (2), and (3) show increased shoulder compared to the control coating (sample 8). Inventive samples 9-11 with compound (1) also show speed increase over that of the control sample 8. After a two week storage at 120° F., all of the inventive samples (9-17) have reduced fog growth relative to the control check. In addition, samples 10 and 11 with the inventive compound (1) also have reduced speed gain when stored under high temperature and humidity conditions without any loss in fresh sensitivity.

### Example 3

In another practice of the invention, compound (1) was evaluated along with a conventional antifoggant in the same negative iodochloride emulsion as in Example 1. The antifoggant, compound (AI) in amounts indicated in Table (3), was added along with compound (BI) (AI/BI present in a ratio of 10/1) to the yellow dispersion of Example 1. The emulsions were coated, and the coatings exposed and processed as for previous examples.

TABLE 3

| | (1) (AI) + (BI) | | | | |
|---|---|---|---|---|---|
| | mg | | Fresh | | |
| Sample | Ag mol | | SPEED | D-MIN | SHOULDER |
| 18 (comparison) | 0 | 0 | 1.661 | 0.091 | 1.899 |
| 19 (comparison) | 0 | 750 | 1.659 | 0.091 | 1.909 |
| 20 (invention) | 150 | 0 | 1.663 | 0.092 | 1.920 |
| 21 (invention) | 250 | 0 | 1.662 | 0.090 | 1.903 |
| 22 (invention) | 350 | 0 | 1.662 | 0.091 | 1.904 |
| 23 (invention) | 150 | 750 | 1.668 | 0.090 | 1.926 |
| 24 (invention) | 250 | 750 | 1.658 | 0.090 | 1.915 |
| 25 (invention) | 350 | 750 | 1.659 | 0.090 | 1.912 |

It can be seen in Table 3 that the shoulder enhancing benefits of compound (1) of the present invention (samples 20-22) are realized by addition of (1) to the emulsion. It is, however, more beneficial to add a mixture of compounds (Al) and (BI) in addition to compound (1) to the emulsion since the shoulder increase is more for the combinations of (1), (AI), and (BI) (samples 23-25) than those (AI) and (BI) by themselves (sample 19) or with (1) (samples 20-22). In addition, there is a slight increase in emulsion sensitivity in the inventive sample (sample 23) where (1) and (AI), (BI) were added to the emulsion than samples where (1) or (AI) and (BI) were added to the emulsion by themselves.

The invention has been described in detail with particular reference to the preferred embodiments thereof, but it will be understood that variations and modifications can be effected within the scope of the invention.

1. A silver halide photographic element comprising a support and a silver halide emulsion layer, said emulsion layer being in reactive association with a thiocyanato compound represented by formula I:
PUG-SCN (I)
wherein PUG represents a photographically useful group; and wherein upon chemical processing, PUG-SCN releases in a non-image-wise fashion a photographically useful mercaptan, PUG-S.

2. The silver halide photographic element of claim 1 wherein the silver halide emulsion layer is predominantly silver chloride.

3. The silver halide photographic element of claim 2 wherein PUG is a stabilizer or a tone scale modifier.

4. The silver halide photographic element of claim 2 wherein PUG is a substituted or unsubstituted aliphatic group, aromatic group or heteroaromatic group.

5. The silver halide photographic element of claim 2 wherein PUG is an aliphatic group having from 2 to 12 carbon atoms, an aromatic group having from 6 to 20 carbon atoms or a 3- to 15-membered heteroaromatic group.

6. The silver halide photographic element of claim 2 wherein PUG is an aromatic group having 6 to 10 carbon atoms or a 5- to 6-membered heteroaromatic group, with at least one hetero atom selected from nitrogen, oxygen, sulfur, selenium, and tellurium.

7. The silver halide photographic element of claim 2 wherein PUG is a 5- to 6-membered heteroaromatic group, with at least one hetero atom selected from nitrogen, oxygen, sulfur, selenium, and tellurium.

8. The silver halide photographic element of claim 5 wherein PUG is a a heteroaromatic group.

9. The silver halide photographic element of claim 6 wherein PUG is a a heteroaromatic group.

10. The silver halide photographic element of claim 6 wherein PUG is a substituted or unsubstituted phenyl substituted tetrazole.

11. The silver halide photographic of claim 2 wherein the emulsion layer comprises greater than about 90 mol percent silver chloride.

12. The silver halide photographic element of claim 2 wherein the emulsion layer comprises greater than about 95 mol percent silver chloride.

13. The silver halide photographic of claim 5 wherein the emulsion layer comprises greater than about 90 mol percent silver chloride.

14. The silver halide photographic element of claim 5 wherein the emulsion layer comprises greater than about 95 mol percent silver chloride.

15. The silver halide photographic element of claim 1 containing from about 0.1 to about 5,000 mg per silver mol of the thiocyanato compound.

16. The photographic element of claim 15 containing from about 10 to about 1,000 mg per silver mol of the thiocyanato compound.

17. The photographic element of claim 1 further comprising in reactive association with the silver halide emulsion a compound represented by Formula A (ArSO₂SM) and a compound represented by Formula B (ArSO₂M) wherein Ar is an aromatic group and M is a cationic counterion.

18. The photographic element of claim 17 wherein Ar is an aromatic group having 6 to 10 carbon atoms and M is an alkali metal or an ammonium group.

19. The photographic element of claim 1 further comprising in reactive association with the silver halide emulsion Compound AI and Compound BI:

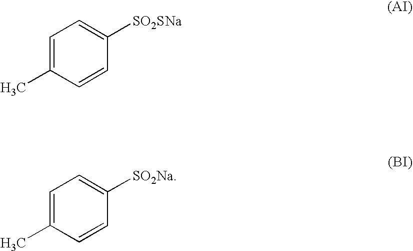

20. The photographic element of claim I wherein the thiocyanato compound is a solid particle dispersion.
